(19) United States
(12) Patent Application Publication
(10) Pub. No.: US 2021/0392499 A1
(43) Pub. Date: Dec. 16, 2021

(54) SECURE WIRELESS DATA DEVICES AND METHODS OF USE

(71) Applicants: Cynthia Fascenelli Kirkeby, Orange, CA (US); Anthony Suk Ko, Yorba Linda, CA (US)

(72) Inventors: Cynthia Fascenelli Kirkeby, Orange, CA (US); Anthony Suk Ko, Yorba Linda, CA (US)

(21) Appl. No.: 17/283,123

(22) PCT Filed: Oct. 9, 2019
(86) PCT No.: PCT/US2019/055385

§ 371 Date: Apr. 6, 2021

Related U.S. Application Data
(60) Provisional application No. 62/744,647, filed on Oct. 12, 2018.

(51) Int. Cl. H04W 12/47; H04W 12/088; H04W 12/06

(52) U.S. Cl. CPC H04W 12/47; H04W 12/06; H04W 12/088

(57) ABSTRACT

A secure wireless data device is disclosed and configured as at least one of a passive, semi-passive, or active RFID or NFC enabled device. In at least one embodiment, the data device provides a memory, an antenna and an at least one access sensor. The memory is configured for storing select wireless data therein. The antenna is in selective wireless communication with a compatible reader. The at least one access sensor is configured for automatically switching between an enabled state—wherein the wireless data is capable of being accessed by the reader—and a disabled state—wherein the wireless data is prevented from being accessed by the reader—based on an at least one measurable physical parameter that is detectable by the at least one access sensor.

### RELATED APPLICATIONS

This application claims priority and is entitled to the filing date of U.S. provisional application Ser. No. 62/744,647, filed on Oct. 12, 2018. The contents of the aforementioned application are incorporated herein by reference.

### BACKGROUND

The subject of this patent application relates generally to device security, and more particularly to secure wireless data devices and associated methods of use for selectively controlling activation, deactivation, data access, data transmission and read/write/rewrite functionality of RFID and NFC enabled devices.

Applicant(s) hereby incorporate herein by reference any and all patents and published patent applications cited or referred to in this application.

By way of background, as illustrated in FIG. 1, radio frequency identification (“RFID”) and near field communication (“NFC”) systems are short-range (or in some cases mid- to long-range) radio frequency and standards-based wireless connectivity technologies which enable communication between devices that are often (although not exclusively) held or positioned a relatively short distance apart from one another. At certain frequencies, these RFID and NFC systems can work over surprisingly long distances. Both of these technologies utilize inductive coupling 100, a process that transfers data and/or energy through a shared magnetic field 102 between two devices. The RFID and NFC enabled devices 104—hereinafter referred to generally as “wireless devices” for simplicity purposes—are identified as either passive, semi-passive, or active. Passive wireless devices require a scanner, reader or similar transceiver device 106—hereinafter referred to generally as a “reader” for simplicity purposes—to provide the necessary power to create the connection and power a data transfer. Semi-passive wireless devices use a battery to help provide power for their data functions and to boost their transmission range, while relying on the reader 106 to supply power for broadcasting. Active wireless devices are self-powered devices that do not require the power from a reader to complete their data functions. Standard RFID systems are normally capable of single direction data transfer 108, while NFC systems are typically capable of two-way data transfer 108.

The range of a wireless device's data transfer capability is dependent on a number of factors including the frequency of the system, type of antenna, characteristics and materials of the wireless device, the environment, form of attachment, and whether the wireless device is active or passive. Currently, the functional distances of such wireless devices range from essentially touching to two (2) kilometers or more. With advancing technologies, these data transfer ranges will undoubtedly increase. Passive wireless devices were previously limited to only 1.5 meters; however, the readable distance for current passive wireless devices has increased to approximately 16 meters. Active wireless devices, especially in the 433 MHz ultra high frequency (“UHF”) range, are capable of surprising long-distance data transmissions, currently reaching over two (2) kilometers.

Despite the widespread use of RFID and NFC systems across virtually all industries, they have a serious vulnerability that stems from a core design characteristic of the RFID and NFC technologies—namely, the ability to activate and read these wireless devices using compatible radio frequency readers within range of said wireless devices. In many of these cases, RFID and NFC readers are controlled by individuals with malicious intentions. This vulnerability is especially problematic since these wireless devices, more and more frequently, contain personally identifiable or confidential information. As RFID and NFC based data storage and transmission has become a more popular method of making financial transactions, the danger of fraudulent transactions made with the help of malicious scanners is becoming increasingly serious. Although many RFID and NFC systems are not well-protected, some of these systems are now cryptographically protected. Such systems, however, can be cracked, or decoded, making the stored data vulnerable.

These RFID and NFC wireless devices are now used in everything from payment and health insurance cards to product labels to industrial-level tags attached to critical machinery, and they carry information that may include anything from general product data, specialized industry data, or even sensitive individual financial and health information. Standard RFID and NFC enabled payment cards, along with other RFID and NFC enabled objects, can be scanned regardless of placement, orientation, or other physical constraints or parameters. Consumers with RFID and NFC enabled payment cards have resorted to using specialized wallets and other shielded products that attempt to block malicious scanners; but more proactive countermeasures are needed, both in the consumer goods arena as well as the industrial sector. As illustrated in FIG. 2, many types of consumer goods 110 are using wireless devices 104 for product inventory tracking and to fight counterfeiters. This leaves consumers rightfully concerned about the items they have purchased, which they may be wearing or have in their possession, that are capable of transmitting sensitive data to nefarious strangers using covert scanning devices 106 within scanning range. This is especially concerning when these tags contain, or are associated with, unique, personally identifying information—or in the case of the industrial or government sectors, highly sensitive operational or logistical data.

Thus, again, there remains a need for a device capable of eliminating these vulnerabilities. Aspects of the present invention fulfill these needs and provide further related advantages as described in the following summary.

It should be noted that the above background description includes information that may be useful in understanding aspects of the present invention. It is not an admission that any of the information provided herein is prior art or relevant to the presently claimed invention, or that any publication specifically or implicitly referenced is prior art.

### SUMMARY

Aspects of the present invention teach certain benefits in construction and use which give rise to the exemplary advantages described below.

The present invention solves the problems described above by providing a secure wireless data device and associated methods of use for selectively controlling activation, deactivation, data access, data transmission and read/write/rewrite functionality of RFID and NFC enabled devices. In at least one embodiment, the data device is configured as at least one of a passive, semi-passive, or active RFID or NFC enabled device. In at least one embodiment, the data device provides a memory, an antenna and an at least one access sensor. The memory is configured for storing select wireless data therein. The antenna is in selective wireless communication with a compatible reader. The at least one access sensor is configured for automatically switching between an enabled state—wherein the wireless data is capable of being accessed by the reader—and a disabled state—wherein the wireless data is prevented from being accessed by the reader—based on an at least one measurable physical parameter that is detectable by the at least one access sensor.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a diagrammatic view of a prior art RFID or NFC device in wireless communication with a compatible reader;

FIG. 2 is a diagrammatic view of a prior art RFID or NFC device, as attached to a consumer product, in wireless communication with a compatible reader;

FIG. 3 is a simplified schematic view of an exemplary secure wireless data device in selective wireless communication with a compatible reader, in accordance with at least one embodiment;

FIGS. 4-6 are diagrammatic views of an exemplary secure wireless data device in selective wireless communication with a compatible reader, wherein the secure wireless data device incorporates an exemplary light sensor, in accordance with at least one embodiment;

FIGS. 7 and 8 are diagrammatic views of an exemplary secure wireless data device in selective wireless communication with a compatible reader, wherein the secure wireless data device incorporates an exemplary temperature sensor, in accordance with at least one embodiment;

FIGS. 9 and 10 are diagrammatic views of an exemplary secure wireless data device in selective wireless communication with a compatible reader, wherein the secure wireless data device incorporates an exemplary moisture sensor, in accordance with at least one embodiment;

FIGS. 11 and 12 are diagrammatic views of an exemplary secure wireless data device in selective wireless communication with a compatible reader, wherein the secure wireless data device incorporates an exemplary location sensor, in accordance with at least one embodiment;

FIGS. 13 and 14 are diagrammatic views of an exemplary secure wireless data device in selective wireless communication with a compatible reader, wherein the secure wireless data device incorporates an exemplary orientation sensor, in accordance with at least one embodiment;

FIGS. 15 and 16 are diagrammatic views of an exemplary secure wireless data device in selective wireless communication with a compatible reader, wherein the secure wireless data device incorporates an exemplary acoustic sensor, in accordance with at least one embodiment;

FIGS. 17 and 18 are diagrammatic views of an exemplary secure wireless data device in selective wireless communication with a compatible reader, wherein the secure wireless data device incorporates an exemplary gas sensor, in accordance with at least one embodiment;

FIGS. 19 and 20 are diagrammatic views of an exemplary secure wireless data device in selective wireless communication with a compatible reader, wherein the secure wireless data device incorporates an exemplary chemical sensor, in accordance with at least one embodiment;

FIGS. 21 and 22 are diagrammatic views of an exemplary secure wireless data device in selective wireless communication with a compatible reader, wherein the secure wireless data device incorporates an exemplary radiation sensor, in accordance with at least one embodiment;

FIGS. 23 and 24 are diagrammatic views of an exemplary secure wireless data device in selective wireless communication with a compatible reader, wherein the secure wireless data device incorporates an exemplary time sensor, in accordance with at least one embodiment;

FIGS. 25 and 26 are diagrammatic views of an exemplary secure wireless data device in selective wireless communication with a compatible reader, wherein the secure wireless data device incorporates an exemplary pressure sensor, in accordance with at least one embodiment;

FIG. 27 is a flow diagram of an exemplary method for communicating with active and semi-passive embodiments of the exemplary secure wireless data device, in accordance with at least one embodiment; and

FIG. 28 is a flow diagram of an exemplary method for communicating with passive embodiments of the exemplary secure wireless data device, in accordance with at least one embodiment.

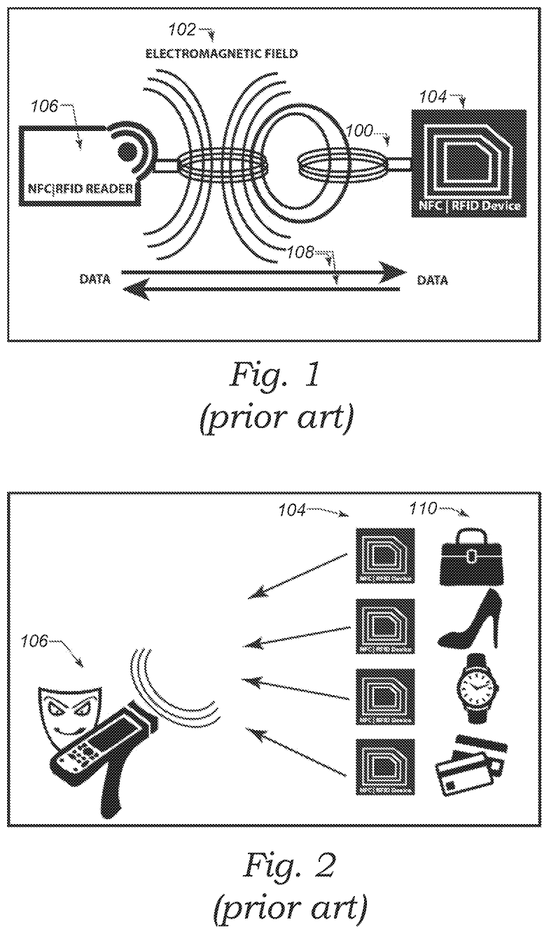

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

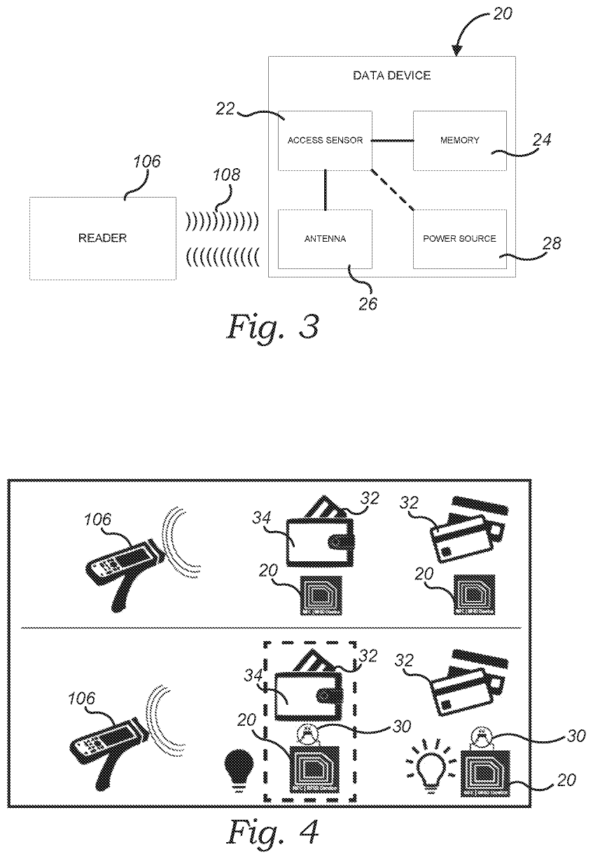

Turning now to FIG. 3, there is shown a simplified schematic view of an exemplary embodiment of a secure wireless data device 20 in selective wireless communication with a compatible reader 106. In at least one embodiment, the data device 20 is configured as at least one of a passive, semi-passive, or active RFID or NFC enabled tag, chip or device (hereinafter referred to generally as a “device” for simplicity purposes). Accordingly, in at least one embodiment, the data device 20 is configured as at least one of a payment card 32, a label, a sticker, a consumer product, or a piece of industrial equipment. However, this list of possible embodiments is in no way exhaustive. In still further embodiments, the data device 20 may take on any other configuration—now known or later developed—where the utilization of an RFID or NFC enabled device is desired. In at least one embodiment, rather than the RFID and/or NFC data—hereinafter referred to generally as “wireless data” for simplicity purposes—always being accessible (as is the case for traditional RFID and NFC enabled devices), the wireless data's accessibility is instead limited by virtue of an at least one access sensor 22 provided by the data device 20, which automatically controls access to the readability of the data device 20—and, in turn, the wireless data stored thereon—based on a change in an at least one measurable physical parameter that is detectable by the at least one access sensor 22, thereby selectively controlling the access to, and reducing the misuse of, the wireless data stored on the data device 20.

In a bit more detail, in at least one embodiment, the data device 20 provides a memory 24 configured for storing the wireless data therein, along with an antenna 26 configured for transmitting the wireless data to the reader 106. Additionally, the data device 20 provides the at least one access sensor 22 in electrical communication with each of the memory 24 and antenna 26, such that the access sensor 22 is capable of selectively disabling communication between the memory 24 and the antenna 26, as discussed further below. In at least one embodiment, the at least one access sensor 22 is configured as a physical switch, wherein electrical communication between the memory 24 and the antenna 26 is selectively connected and disconnected by the at least one access sensor 22. In at least one alternate embodiment, rather than physically connecting and disconnecting electrical communication between the memory 24 and the antenna 26, the at least one access sensor 22 instead simply allows or prevents transmission of the wireless data from the memory 24 to the antenna 26. In each of these embodiments, the at least one access sensor 22 is configured for automatically switching between an enabled state—wherein the wireless data is capable of being accessed, transmitted, written, and/or rewritten by the reader 106 (hereinafter referred to generally as “accessed” for simplicity purposes)—and a disabled state—wherein the wireless data is prevented from being accessed by the reader 106—based on a change in an at least one measurable physical parameter that is detectable by the at least one access sensor 22, as discussed further below. It should be noted that the arrangement and interconnection of components depicted in FIG. 3 is merely exemplary and is being shown simply for illustrative purposes. In further embodiments, the arrangement and interconnection of components may vary. For example, in at least one such further embodiment, where the data device 20 provides a power source 28 (such as a battery, for example), the at least one access sensor 22 may be positioned in electrical communication between the power source 28 and the memory 24. In such embodiments, the at least one access sensor 22 is capable of selectively disconnecting the memory 24 from the power source 28 (which, in turn, prevents the wireless data from being accessed by the reader 106) while in the disabled state, and connecting the memory 24 with the power source 28 (which, in turn, allows the wireless data to be accessed by the reader 106) while in the enabled state.

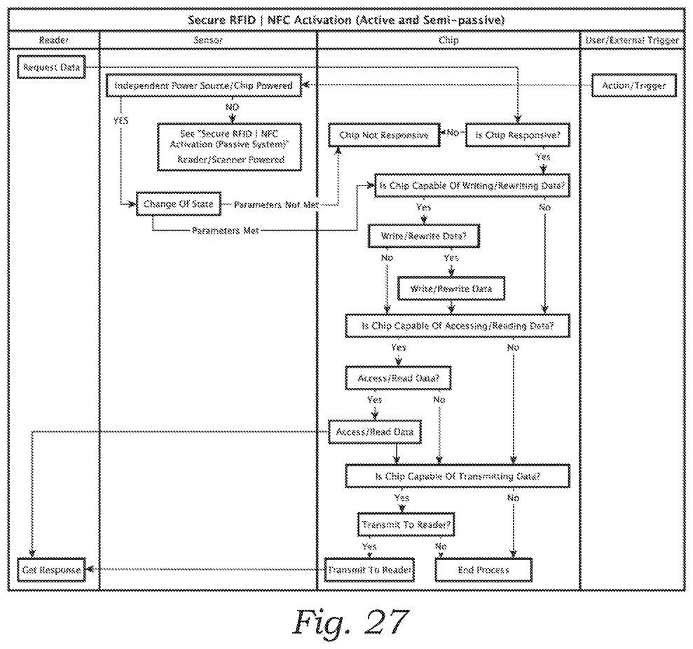

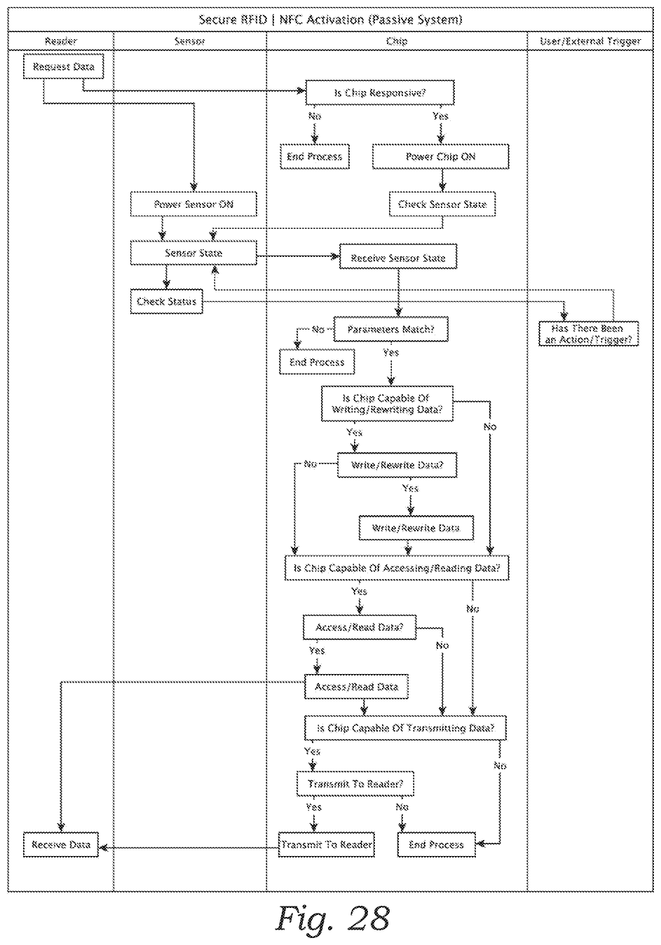

In general, in at least one embodiment, the methods of using the data device 20 are illustrated in the flow diagrams of FIGS. 27 (where the data device 20 is configured as an active or semi-passive RFID or NFC enabled device) and 28 (where the data device 20 is configured as a passive RFID or NFC enabled device). However, in each of the various embodiments of the present invention, the physical parameters of the at least one access sensor 22 will vary, as well as the specific response(s) of the at least one access sensor 22. As discussed in detail below, the at least one access sensor 22 may be configured for detecting and/or measuring a wide variety of different physical parameters, based on which the at least one access sensor 22 would automatically switch between the enabled and disabled states—and vice versa. The specific type of access sensor 22 to be incorporated into the data device 20 in any given embodiment would depend, at least in part, on the specific context in which the data device 20 is to be utilized. It should also be noted that the following embodiments are intended to be non-limiting examples which are being provided for illustrative purposes only, in order to facilitate a more complete understanding of representative embodiments of the data device 20 currently contemplated. These examples are intended to be a mere subset of all possible configurations and contexts in which the data device 20 may be utilized. Thus, these examples should not be construed to limit any of the embodiments described in the present specification, or the types of access sensors 22 that might be utilized by the data device 20. Ultimately, the data device 20 may be utilized in virtually any context where the use of an RFID or NFC enabled device is desired. Furthermore, the at least one access sensor 22 may be any sensor (or combination of sensors)—now known or later developed—capable of detecting and/or measuring a desired physical parameter.

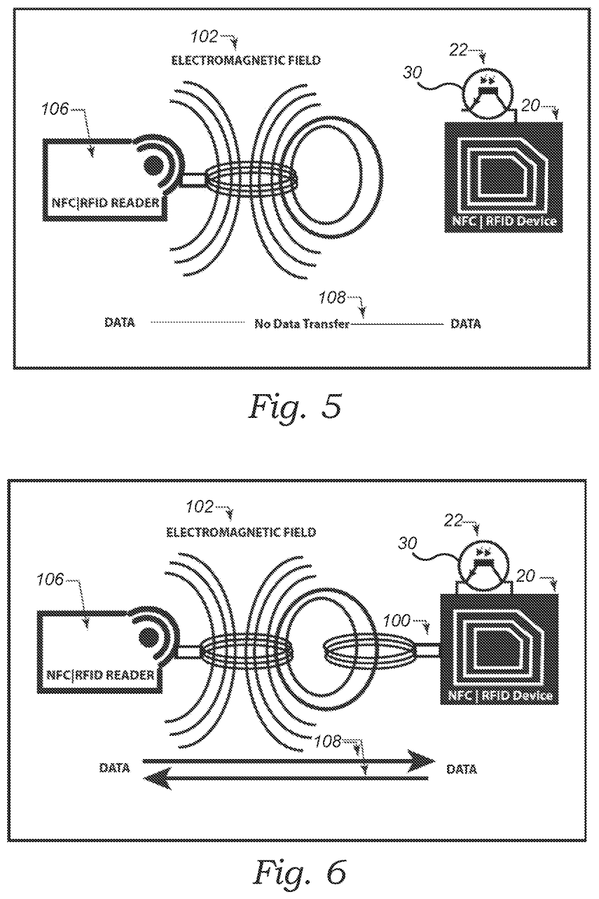

In at least one embodiment, as illustrated in FIGS. 4-6, the at least one access sensor 22 is a light sensor 30 configured for detecting the presence of light or, alternatively, measuring an amount of said light in the environment in which the data device 20 is positioned. Examples of such light sensors 30 include—but are in no way limited to—photovoltaic sensors, light dependent sensors (“LDR”), infrared (“IR”) sensors, proximity light sensors, photo diode sensors, photoconductive sensors, phototransistors, etc. In at least one such embodiment, the at least one access sensor 22 is configured for automatically switching to the enabled state (FIG. 6) upon detecting the presence of light—thereby allowing the wireless data to be accessed by the reader 106—and automatically switching to the disabled state (FIG. 5) upon detecting an absence of light—thereby preventing the wireless data from being accessed by the reader 106. In at least one alternate embodiment, the at least one access sensor 22 is configured for automatically switching to the enabled state (FIG. 6) upon determining that a pre-defined minimum amount of light (such as 250 lux, for example) is present—thereby allowing the wireless data to be accessed by the reader 106—and automatically switching to the disabled state (FIG. 5) upon determining that the pre-defined minimum amount of light is not present—thereby preventing the wireless data from being accessed by the reader 106. In at least one such embodiment, the data device 20 is incorporated into an RFID or NFC enabled payment card 32 (FIG. 4). Thus, when the payment card 32 is positioned in a dark (or near dark) location—such as the owner's wallet 34, purse or pocket, for example—the at least one access sensor 22 would automatically switch to the disabled state, thereby preventing unauthorized access to the wireless data via an unintended reader 106. Upon the owner removing the payment card 32 from their wallet 34/purse/pocket/etc. in order to utilize the payment card 32 (thereby exposing the at least one access sensor 22 to a sufficient amount of light), the at least one access sensor 22 would automatically switch to the enabled state, thereby allowing access to the wireless data via an intended reader 106. In at least one further alternate embodiment, depending on the context in which the data device 20 is utilized, the various criteria described above for causing the access sensor 22 to automatically switch between enabled and disabled states may be swapped, such that the criteria for switching to the enabled state would instead be used to switch to the disabled state, and vice versa.

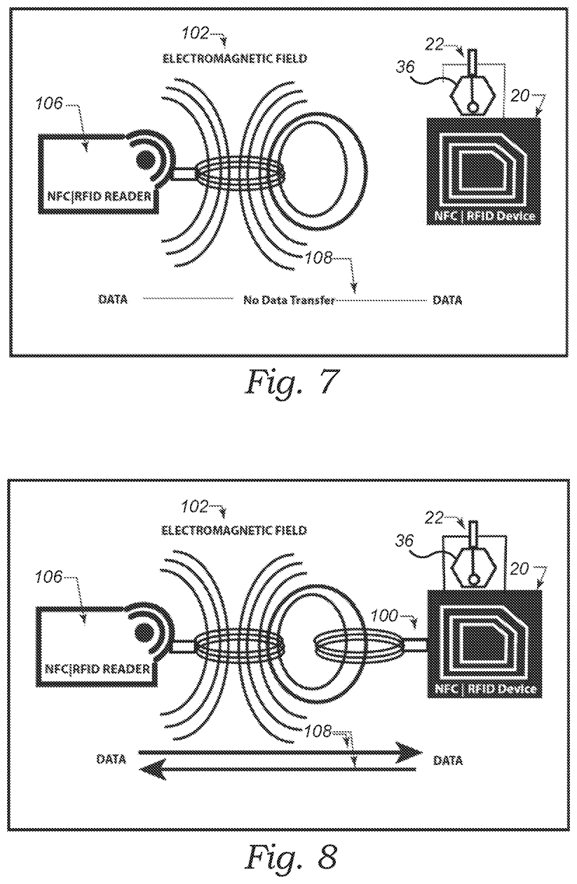

In at least one further embodiment, as illustrated in FIGS. 7 and 8, the at least one access sensor 22 is a temperature sensor 36 configured for measuring the temperature of the environment in which the data device 20 is positioned. Examples of such temperature sensors 36 include—but are in no way limited to—thermistors, RTDs resistance temperature detectors (“RTD”), thermocouples, negative temperature coefficient (“NTC”) thermistors, semiconductor-based temperature sensors, heat dissipation sensors, enthalpic sensors, etc. In at least one such embodiment, the at least one access sensor 22 is configured for automatically switching to the enabled state (FIG. 8) upon determining that a pre-defined minimum or maximum temperature is present (or alternatively, upon determining that the temperature falls within a pre-defined range)—thereby allowing the wireless data to be accessed by the reader 106—and automatically switching to the disabled state (FIG. 7) upon determining that the pre-defined minimum or maximum temperature is not present (or alternatively, upon determining that the temperature falls outside of a pre-defined range)—thereby preventing the wireless data from being accessed by the reader 106. In at least one alternate embodiment, depending on the context in which the data device 20 is utilized, the various criteria described above for causing the access sensor 22 to automatically switch between enabled and disabled states may be swapped, such that the criteria for switching to the enabled state would instead be used to switch to the disabled state, and vice versa. Such embodiments of the data device 20 could be used in contexts such as protecting personal data on a wilderness identification tag that could not be read unless the data device 20 were exposed to extreme temperatures. In at least one such embodiment, if the temperature exceeds a specified limit on either end of a range, the data device 20 would then activate and transmit personal data identifying the user and the fact that the user is in a health endangering situation. In at least one further embodiment, this would be used in avalanche conditions where at least one of a temperature sensor 36, orientation sensor 42, and locational sensor 40 would identify a crisis where access to the personal data would be necessary.

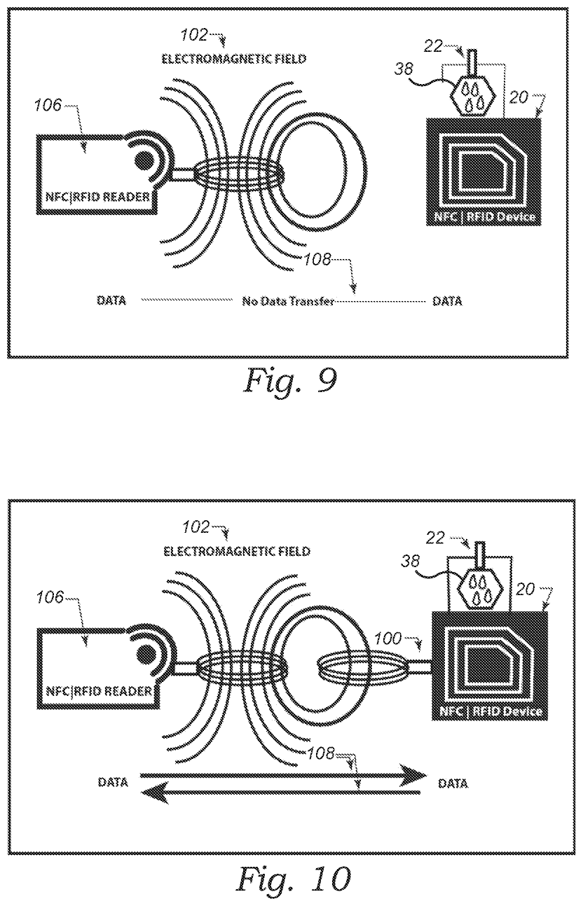

In at least one further embodiment, as illustrated in FIGS. 9 and 10, the at least one access sensor 22 is a moisture sensor 38 configured for detecting the presence of moisture or, alternatively, measuring an amount of said moisture in the environment in which the data device 20 is positioned. Examples of such moisture sensors 38 include—but are in no way limited to—humidity sensors, precipitation sensors, moisture probes, neutron moisture probes, dielectric soil sensors, hygrometer sensors, inductive proximity sensors, etc. In at least one such embodiment, the at least one access sensor 22 is configured for automatically switching to the enabled state (FIG. 10) upon detecting the presence of moisture—thereby allowing the wireless data to be accessed by the reader 106—and automatically switching to the disabled state (FIG. 9) upon detecting an absence of moisture—thereby preventing the wireless data from being accessed by the reader 106. In at least one alternate embodiment, the at least one access sensor 22 is configured for automatically switching to the enabled state (FIG. 10) upon determining that a pre-defined minimum amount of moisture is present (or alternatively, upon determining that the moisture amount falls within a pre-defined range)—thereby allowing the wireless data to be accessed by the reader 106—and automatically switching to the disabled state (FIG. 9) upon determining that the pre-defined minimum amount of moisture is not present (or alternatively, upon determining that the moisture amount falls outside of a pre-defined range)—thereby preventing the wireless data from being accessed by the reader 106. In at least one further alternate embodiment, depending on the context in which the data device 20 is utilized, the various criteria described above for causing the access sensor 22 to automatically switch between enabled and disabled states may be swapped, such that the criteria for switching to the enabled state would instead be used to switch to the disabled state, and vice versa. Such embodiments of the data device 20 could be used in contexts such as in summer camp and scouting organizations, with the at least one access sensor 22 automatically switching between the enabled and disabled states upon the data device 20 becoming too wet, thereby indicating that a child has fallen into a water feature such as a stream, pool, or fountain, thereby allowing notification that the child is in distress, as well as who and where they are located, while at the same time protecting the other participants from having their personal information exposed to strangers.

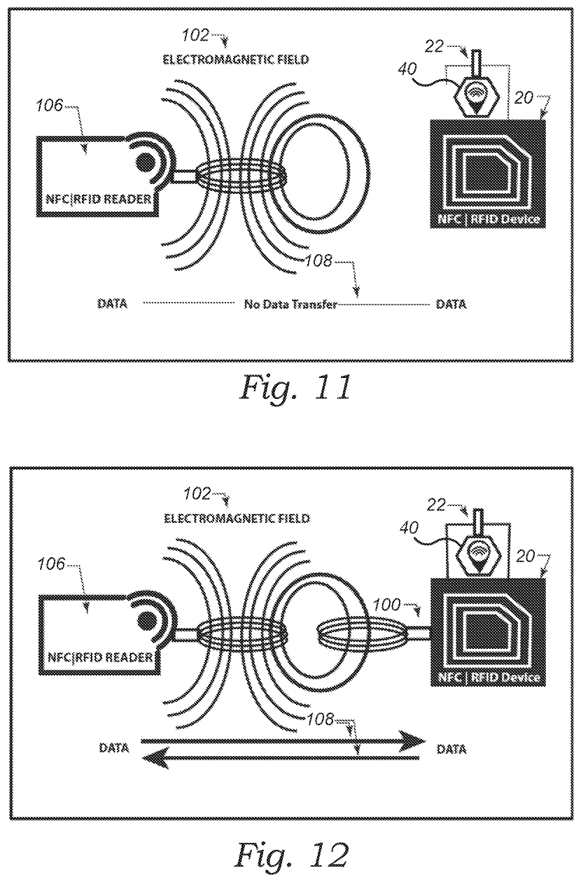

In at least one further embodiment, as illustrated in FIGS. 11 and 12, the at least one access sensor 22 is a location sensor 40 configured for measuring a current location of the data device 20—either in the environment generally or relative to another object. Examples of such location sensors 40 include—but are in no way limited to—two-dimensional global or polar positioning sensors, global positioning system (“GPS”) sensors, altitude sensors, proximity sensors, optical sensors, motion sensors, etc. In at least one such embodiment, the at least one access sensor 22 is configured for automatically switching to the enabled state (FIG. 12) upon determining that the current location of the data device 20 falls within a pre-defined range of geographic coordinates (or, alternatively, is within a pre-defined proximity to a given object)—thereby allowing the wireless data to be accessed by the reader 106—and automatically switching to the disabled state (FIG. 11) upon determining that the current location of the data device 20 falls outside of a pre-defined range of geographic coordinates (or, alternatively, is not within a pre-defined proximity to a given object)—thereby preventing the wireless data from being accessed by the reader 106. In at least one further alternate embodiment, depending on the context in which the data device 20 is utilized, the various criteria described above for causing the access sensor 22 to automatically switch between enabled and disabled states may be swapped, such that the criteria for switching to the enabled state would instead be used to switch to the disabled state, and vice versa. Such embodiments of the data device 20 could be used in contexts such as in social, logistic, corporate, or nautical data collection. Another exemplary context is aeronautics, wherein the data device 20 could allow access to the specialized RFID data, such as military targeting data, only when the access sensor 22 identifies that a plane is at a specific altitude and within a geographic region, otherwise making the data and equipment inaccessible.

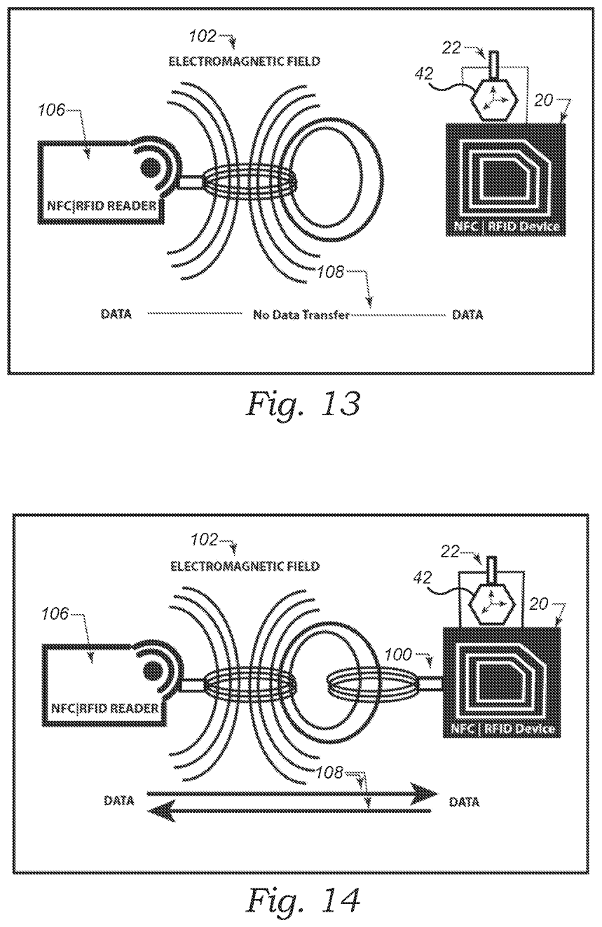

In at least one further embodiment, as illustrated in FIGS. 13 and 14, the at least one access sensor 22 is an orientation sensor 42 configured for measuring a current orientation of the data device 20—either in the environment generally or relative to another object. Examples of such orientation sensors 42 include—but are in no way limited to—two-dimensional global or polar positioning sensors, GPS sensors, altitude sensors, proximity sensors, optical sensors, motion sensors, gyroscopic sensors, accelerometer sensors, etc. In at least one such embodiment, the at least one access sensor 22 is configured for automatically switching to the enabled state (FIG. 14) upon determining that the current orientation of the data device 20 falls within a pre-defined range of orientation parameters—thereby allowing the wireless data to be accessed by the reader 106—and automatically switching to the disabled state (FIG. 13) upon determining that the current orientation of the data device 20 falls outside of a pre-defined range of orientation parameters—thereby preventing the wireless data from being accessed by the reader 106. In at least one alternate embodiment, depending on the context in which the data device 20 is utilized, the various criteria described above for causing the access sensor 22 to automatically switch between enabled and disabled states may be swapped, such that the criteria for switching to the enabled state would instead be used to switch to the disabled state, and vice versa. Such embodiments of the data device 20 could be used in contexts such as consumer products. An exemplary context could involve embedding the data device 20 in a shoe, such that the data device 20 could allow access to the wireless data when the associated shoe is turned upside down, which would prevent passersby from retrieving the wireless data covertly.

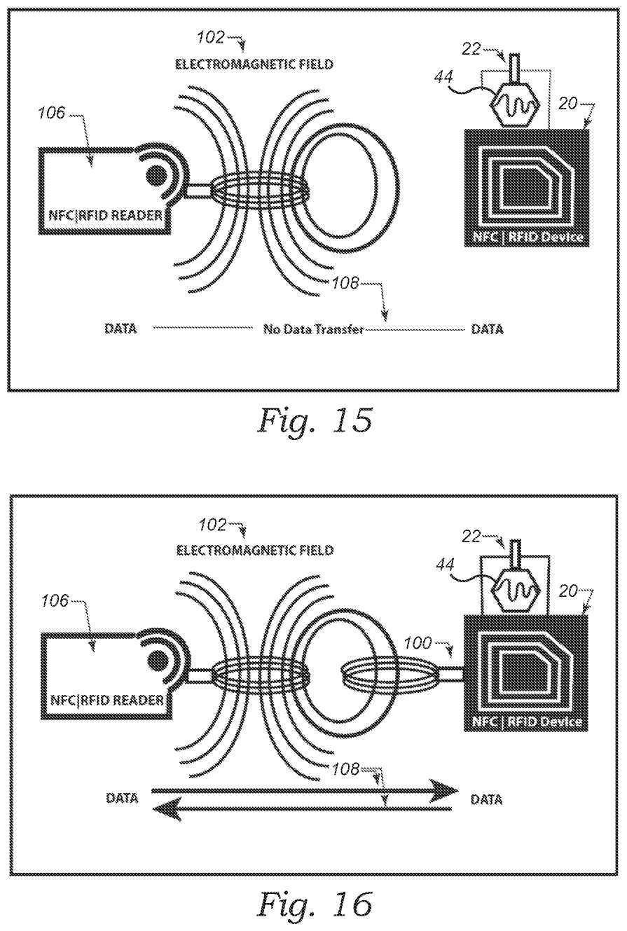

In at least one further embodiment, as illustrated in FIGS. 15 and 16, the at least one access sensor 22 is an acoustic sensor 44 configured for detecting the presence of sound and/or vibration or, alternatively, measuring an amount of said sound and/or vibration in the environment in which the data device 20 is positioned. Examples of such acoustic sensors 44 include—but are in no way limited to—thickness sensor sheer mode resonators, surface acoustic wave (“SAW”) sensors, sheer-horizontal acoustic plate mode sensors, flexural plate wave (“FPW”) sensors, radio sensors, ultrasonic sensors, geophone sensors, hydrophone sensors, lace sensors, seismometer sensors, etc. In at least one such embodiment, the at least one access sensor 22 is configured for automatically switching to the enabled state (FIG. 16) upon detecting the presence of sound/vibration—thereby allowing the wireless data to be accessed by the reader 106—and automatically switching to the disabled state (FIG. 15) upon detecting an absence of sound/vibration—thereby preventing the wireless data from being accessed by the reader 106. In at least one alternate embodiment, the at least one access sensor 22 is configured for automatically switching to the enabled state (FIG. 16) upon determining that a pre-defined minimum amount of sound/vibration is present (or alternatively, upon determining that the sound/vibration amount falls within a pre-defined range)—thereby allowing the wireless data to be accessed by the reader 106—and automatically switching to the disabled state (FIG. 15) upon determining that the pre-defined minimum amount of sound/vibration is not present (or alternatively, upon determining that the sound/vibration amount falls outside of a pre-defined range)—thereby preventing the wireless data from being accessed by the reader 106. In at least one further alternate embodiment, the at least one access sensor 22 is configured for automatically switching to the enabled state (FIG. 16) upon detecting a pre-defined sound or vibration (or a pre-defined pattern of sounds or vibrations)—thereby allowing the wireless data to be accessed by the reader 106—and automatically switching to the disabled state (FIG. 15) upon not detecting such pre-defined sound/vibration or pattern of sounds/vibrations—thereby preventing the wireless data from being accessed by the reader 106. In at least one still further alternate embodiment, depending on the context in which the data device 20 is utilized, the various criteria described above for causing the access sensor 22 to automatically switch between enabled and disabled states may be swapped, such that the criteria for switching to the enabled state would instead be used to switch to the disabled state, and vice versa. Such embodiments of the data device 20 could be used in contexts such as automotive, medical, industrial, and commercial data collection. An exemplary context could involve using the sensor as a form of acoustic or vibration locking device wherein the data device 20 would allow access to the wireless data only when a tonal or vibratory data set meets a specific set of parameters, thereby protecting sensitive data.

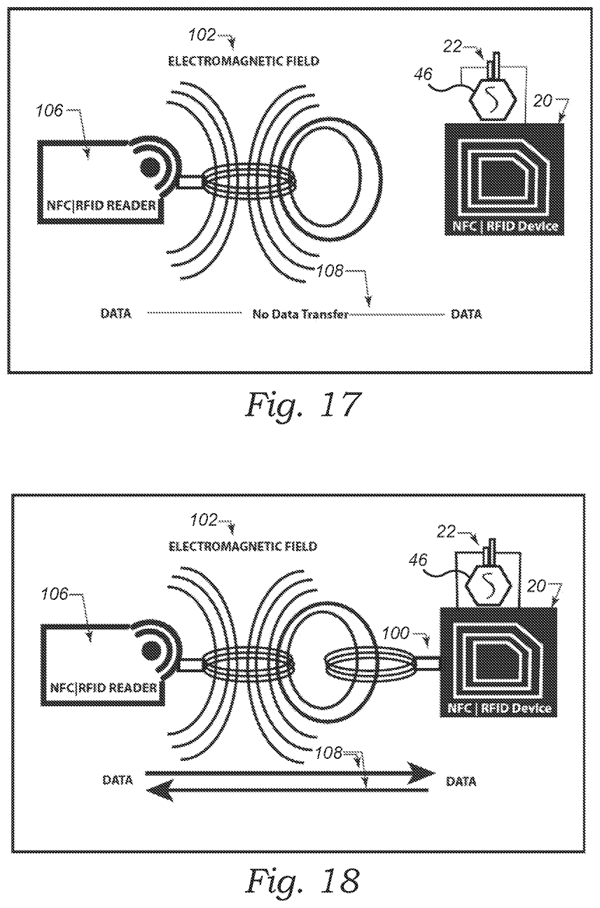

In at least one further embodiment, as illustrated in FIGS. 17 and 18, the at least one access sensor 22 is a gas sensor 46 configured for detecting the presence of one or more particular gases or, alternatively, measuring an amount of said gases in the environment in which the data device 20 is positioned. Examples of such gas sensors 46 include—but are in no way limited to—metal oxide-based gas sensors, optical gas sensors, electrochemical gas sensors, capacitance-based gas sensors, calorimetric gas sensors, acoustic based gas sensors, resistive gas sensors, ceramic gas sensors, ionization smoke sensors, photoelectric smoke sensors, hybrid smoke sensors, etc. In at least one such embodiment, the at least one access sensor 22 is configured for automatically switching to the enabled state (FIG. 18) upon detecting the presence of said gas—thereby allowing the wireless data to be accessed by the reader 106—and automatically switching to the disabled state (FIG. 17) upon detecting an absence of said gas—thereby preventing the wireless data from being accessed by the reader 106. In at least one alternate embodiment, the at least one access sensor 22 is configured for automatically switching to the enabled state (FIG. 18) upon determining that a pre-defined minimum amount of said gas is present (or alternatively, upon determining that the gas amount falls within a pre-defined range)—thereby allowing the wireless data to be accessed by the reader 106—and automatically switching to the disabled state (FIG. 17) upon determining that the pre-defined minimum amount of said gas is not present (or alternatively, upon determining that the gas amount falls outside of a pre-defined range)—thereby preventing the wireless data from being accessed by the reader 106. In at least one further alternate embodiment, depending on the context in which the data device 20 is utilized, the various criteria described above for causing the access sensor 22 to automatically switch between enabled and disabled states may be swapped, such that the criteria for switching to the enabled state would instead be used to switch to the disabled state, and vice versa. Such embodiments of the data device 20 could be used in contexts such as automotive, medical, industrial, and firefighting data collection. An exemplary context could include the release of data on a product sensor in the presence of smoke from fire. This would allow a company to have readable sensors with product specifications with warnings specific to fire, that would be unreadable to personnel under normal circumstances, but would become readable if smoke signaled a danger, thereby allowing firefighters to take specialized precautions related to potentially toxic materials.

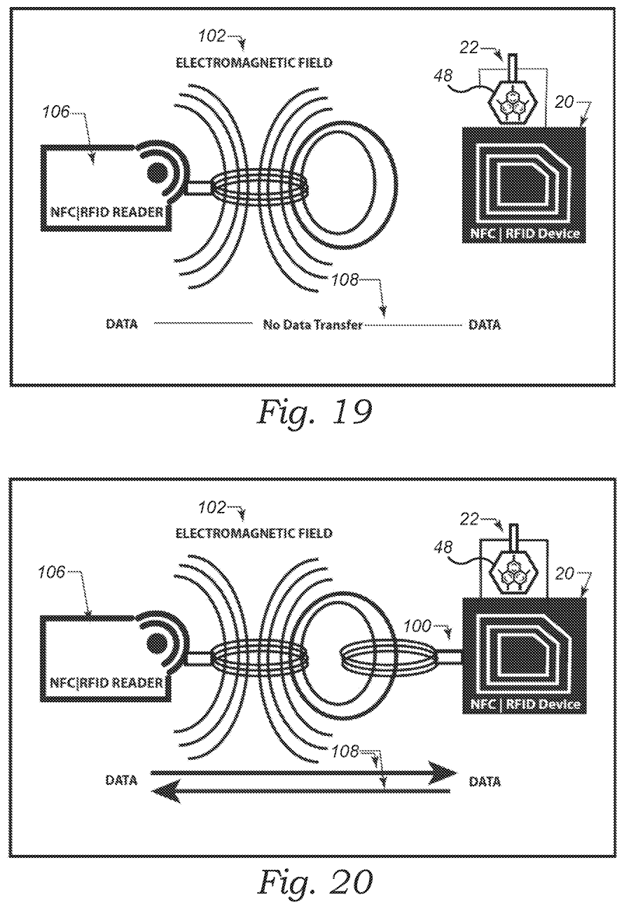

In at least one further embodiment, as illustrated in FIGS. 19 and 20, the at least one access sensor 22 is a chemical sensor 48 configured for detecting the presence of one or more particular chemicals or, alternatively, measuring an amount of said chemicals in the environment in which the data device 20 is positioned. Examples of such chemical sensors 48 include—but are in no way limited to—metal oxide-based gas sensors, optical gas sensors, electrochemical gas sensors, capacitance-based gas sensors, calorimetric gas sensors, acoustic based gas sensors, resistive gas sensors, ceramic gas sensors, ionization smoke sensors, photoelectric smoke sensors, hybrid smoke sensors, ion sensors, resistance sensors, photochemical sensors, photometric sensors, electrochemical sensors, photoelectrochemical sensors, bionic sensors, electrochemiluminescence (“ECL”) sensors, enzyme sensors, etc. In at least one such embodiment, the at least one access sensor 22 is configured for automatically switching to the enabled state (FIG. 20) upon detecting the presence of said chemical—thereby allowing the wireless data to be accessed by the reader 106—and automatically switching to the disabled state (FIG. 19) upon detecting an absence of said chemical—thereby preventing the wireless data from being accessed by the reader 106. In at least one alternate embodiment, the at least one access sensor 22 is configured for automatically switching to the enabled state (FIG. 20) upon determining that a pre-defined minimum amount of said chemical is present (or alternatively, upon determining that the chemical amount falls within a pre-defined range)—thereby allowing the wireless data to be accessed by the reader 106—and automatically switching to the disabled state (FIG. 19) upon determining that the pre-defined minimum amount of said chemical is not present (or alternatively, upon determining that the chemical amount falls outside of a pre-defined range)—thereby preventing the wireless data from being accessed by the reader 106. In at least one further alternate embodiment, depending on the context in which the data device 20 is utilized, the various criteria described above for causing the access sensor 22 to automatically switch between enabled and disabled states may be swapped, such that the criteria for switching to the enabled state would instead be used to switch to the disabled state, and vice versa. Such embodiments of the data device 20 could be used in contexts such as chemical, petroleum, industrial, medical, water treatment, and agricultural data collection. Another exemplary context could involve using the data device 20 as a firefighter tool, wherein the data device 20 would allow access to the wireless data when a level for a toxin is identified outside a set of parameters, This would allow a factory to have sensors with product specifications with warnings specific to fire, that would be unreadable to personnel or outsiders under normal circumstances, but that would become readable if smoke levels signaled a danger, thereby allowing firefighters to take specialized precautions related to potentially toxic materials.

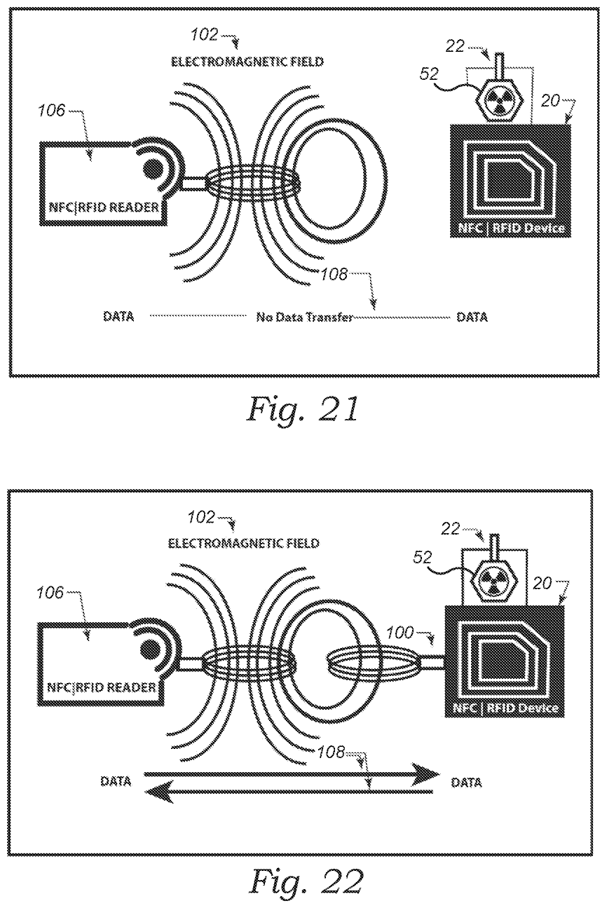

In at least one further embodiment, as illustrated in FIGS. 21 and 22, the at least one access sensor 22 is a radiation sensor 52 configured for detecting the presence of radiation or, alternatively, measuring an amount of said radiation in the environment in which the data device 20 is positioned. Examples of such radiation sensors 52 include—but are in no way limited to—ionization sensors, proportional counter sensors, scintillation sensors, solid state nuclear radiation sensors, etc. In at least one such embodiment, the at least one access sensor 22 is configured for automatically switching to the enabled state (FIG. 22) upon detecting the presence of radiation—thereby allowing the wireless data to be accessed by the reader 106—and automatically switching to the disabled state (FIG. 21) upon detecting an absence of radiation—thereby preventing the wireless data from being accessed by the reader 106. In at least one alternate embodiment, the at least one access sensor 22 is configured for automatically switching to the enabled state (FIG. 22) upon determining that a pre-defined minimum amount of radiation is present (or alternatively, upon determining that the radiation amount falls within a pre-defined range)—thereby allowing the wireless data to be accessed by the reader 106—and automatically switching to the disabled state (FIG. 21) upon determining that the pre-defined minimum amount of radiation is not present (or alternatively, upon determining that the radiation amount falls outside of a pre-defined range)—thereby preventing the wireless data from being accessed by the reader 106. In at least one further alternate embodiment, depending on the context in which the data device 20 is utilized, the various criteria described above for causing the access sensor 22 to automatically switch between enabled and disabled states may be swapped, such that the criteria for switching to the enabled state would instead be used to switch to the disabled state, and vice versa. Such embodiments of the data device 20 could be used in contexts such as industrial, medical, and environmental data collection. Another exemplary context could involve using the data device 20 so as to trigger access to patient data only when the patient is subject to x-rays or radiation during diagnosis or treatment, and optionally transmit the data for analysis or alert upon the at least one access sensor 22 detecting abnormal treatment sensor levels.

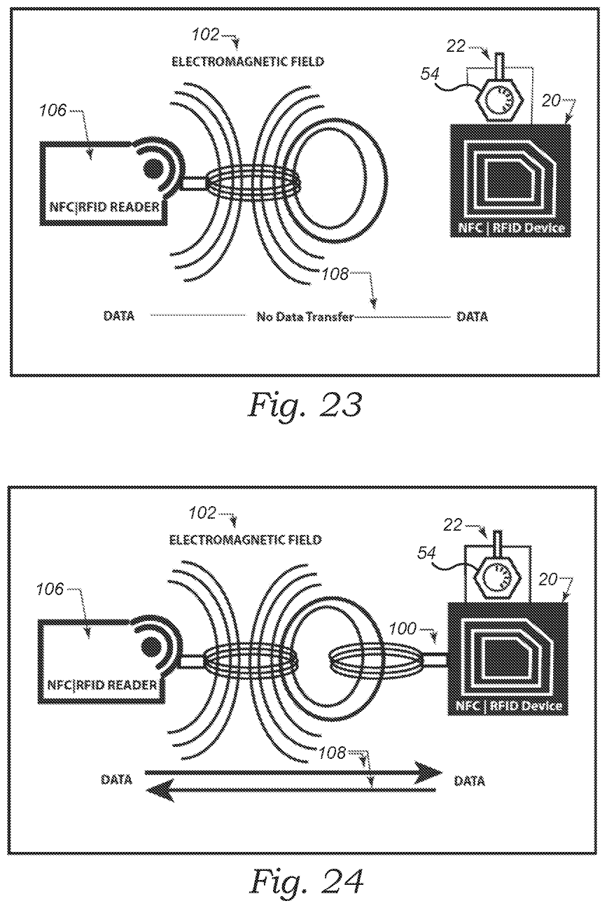

In at least one further embodiment, as illustrated in FIGS. 23 and 24, the at least one access sensor 22 is a time sensor 54 configured for measuring time and/or time intervals. Examples of such time sensors 54 include—but are in no way limited to—flight sensors, simple clocks, UTC sensors, etc. In at least one such embodiment, the at least one access sensor 22 is configured for automatically switching to the enabled state (FIG. 24) upon reaching a pre-defined date and/or time (or alternatively, upon determining that a pre-defined amount of time has elapsed)—thereby allowing the wireless data to be accessed by the reader 106—and automatically switching to the disabled state (FIG. 23) upon determining that the pre-defined date and/or time has not yet been reached (or alternatively, upon determining that a pre-defined amount of time has not yet elapsed)—thereby preventing the wireless data from being accessed by the reader 106. In at least one alternate embodiment, depending on the context in which the data device 20 is utilized, the various criteria described above for causing the access sensor 22 to automatically switch between enabled and disabled states may be swapped, such that the criteria for switching to the enabled state would instead be used to switch to the disabled state, and vice versa. Another exemplary context could involve using the data device 20 so as to trigger a lock-out of data information related to a game or sport, where the information is only available during a specific day and time period, or in the alternative, not accessible during a particular penalty time period.

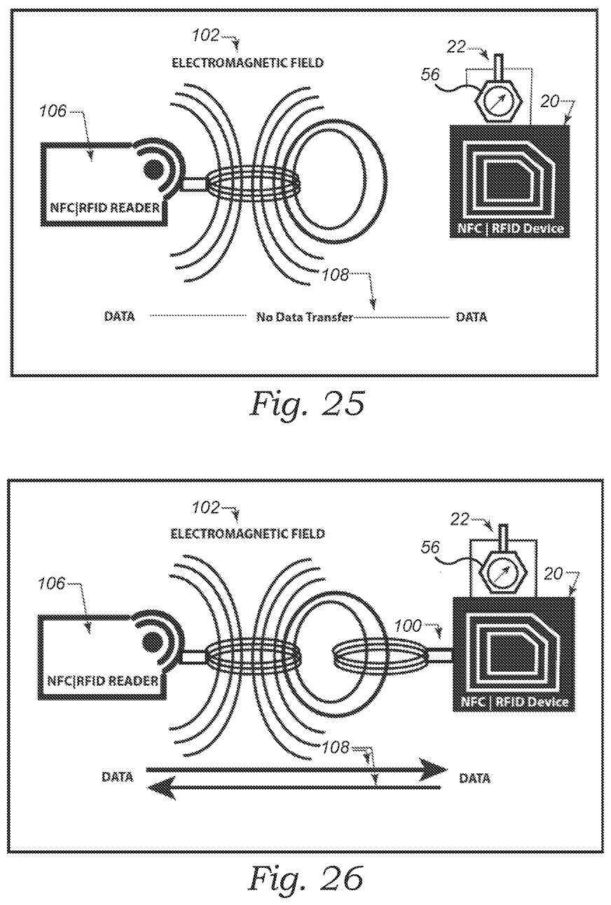

In at least one further embodiment, as illustrated in FIGS. 25 and 26, the at least one access sensor 22 is a pressure sensor 56 configured for measuring an amount of pressure in the environment in which the data device 20 is positioned. Examples of such pressure sensors 56 include—but are in no way limited to—piezoresistive strain gauge pressure sensors, capacitive pressure sensors, electromagnetic pressure sensors, piezoelectric pressure sensors, strain-gauge pressure sensors, optical pressure sensors, potentiometric pressure sensors, force balancing pressure sensors, resonant pressure sensors, thermal pressure sensors, ionization pressure sensors, etc. In at least one such embodiment, the at least one access sensor 22 is configured for automatically switching to the enabled state (FIG. 26) upon determining that a pre-defined minimum amount of pressure is present (or alternatively, upon determining that the pressure amount falls within a pre-defined range)—thereby allowing the wireless data to be accessed by the reader 106—and automatically switching to the disabled state (FIG. 25) upon determining that the pre-defined minimum amount of pressure is not present (or alternatively, upon determining that the pressure amount falls outside of a pre-defined range)—thereby preventing the wireless data from being accessed by the reader 106. In at least one alternate embodiment, depending on the context in which the data device 20 is utilized, the various criteria described above for causing the access sensor 22 to automatically switch between enabled and disabled states may be swapped, such that the criteria for switching to the enabled state would instead be used to switch to the disabled state, and vice versa. Such embodiments of the data device 20 could be used in contexts such as industrial sectors where it is advantageous to keep equipment data secure unless certain conditions are met. Another exemplary context could involve using the data device 20 so that the data can only be accessed by a reader when pressure on the device is above a specified PSI.

Aspects of the present specification may also be described as the following embodiments:

1. A secure wireless data device configured as at least one of a passive, semi-passive, or active RFID or NFC enabled device, the data device comprising: a memory configured for storing select wireless data therein; an antenna in selective wireless communication with a compatible reader; and an at least one access sensor configured for automatically switching between an enabled state—wherein the wireless data is capable of being accessed by the reader—and a disabled state—wherein the wireless data is prevented from being accessed by the reader—based on an at least one measurable physical parameter that is detectable by the at least one access sensor.

2. The data device according to embodiment 1, wherein the at least one access sensor is in electrical communication with each of the memory and antenna, such that the at least one access sensor is capable of selectively disabling communication between the memory and the antenna when the at least one access sensor is in the disabled state.

3. The data device according to embodiments 1-2, wherein the at least one access sensor is configured as a physical switch, wherein electrical communication between the memory and the antenna is selectively connected and disconnected by the at least one access sensor when the at least one access sensor is in the enabled and disabled states, respectively.

4. The data device according to embodiments 1-3, further comprising an at least one power source.

5. The data device according to embodiments 1-4, wherein the at least access sensor is in electrical communication with each of the power source and memory, such that the at least one access sensor is capable of selectively disconnecting the memory from the power source when the at least one access sensor is in the disabled state.

6. The data device according to embodiments 1-5, wherein the data device is configured as a payment card.

7. The data device according to embodiments 1-6, wherein the at least one access sensor is a light sensor configured for detecting light in an environment in which the data device is positioned, such that the at least one measurable physical parameter is light.

8. The data device according to embodiments 1-7, wherein: the at least one access sensor is configured for automatically switching to the enabled state upon detecting the presence of light; and the at least one access sensor is configured for automatically switching to the disabled state upon detecting an absence of light.

9. The data device according to embodiments 1-8, wherein: the at least one access sensor is configured for automatically switching to the enabled state upon determining that a pre-defined minimum amount of light is present; and the at least one access sensor is configured for automatically switching to the disabled state upon determining that the pre-defined minimum amount of light is not present.

10. The data device according to embodiments 1-9, wherein the at least one access sensor is a temperature sensor configured for measuring a temperature of an environment in which the data device is positioned, such that the at least one measurable physical parameter is temperature.

11. The data device according to embodiments 1-10, wherein: the at least one access sensor is configured for automatically switching to the enabled state upon determining that a pre-defined minimum or maximum temperature is present; and the at least one access sensor is configured for automatically switching to the disabled state upon determining that the pre-defined minimum or maximum temperature is not present.

12. The data device according to embodiments 1-11, wherein: the at least one access sensor is configured for automatically switching to the enabled state upon determining that the temperature falls within a pre-defined range; and the at least one access sensor is configured for automatically switching to the disabled state upon determining that the temperature falls outside of a pre-defined range.

13. The data device according to embodiments 1-12, wherein the at least one access sensor is a moisture sensor configured for detecting moisture in an environment in which the data device is positioned, such that the at least one measurable physical parameter is moisture.

14. The data device according to embodiments 1-13, wherein: the at least one access sensor is configured for automatically switching to the enabled state upon detecting the presence of moisture; and the at least one access sensor is configured for automatically switching to the disabled state upon detecting an absence of moisture.

15. The data device according to embodiments 1-14, wherein: the at least one access sensor is configured for automatically switching to the enabled state upon determining that a pre-defined minimum amount of moisture is present; and the at least one access sensor is configured for automatically switching to the disabled state upon determining that the pre-defined minimum amount of moisture is not present.

16. The data device according to embodiments 1-15, wherein: the at least one access sensor is configured for automatically switching to the enabled state upon determining that an amount of moisture detected falls within a pre-defined range; and the at least one access sensor is configured for automatically switching to the disabled state upon determining that an amount of moisture detected falls outside of a pre-defined range.

17. The data device according to embodiments 1-16, wherein the at least one access sensor is a location sensor configured for measuring a current location of the data device relative to either an environment in which the data device is positioned or to another object, such that the at least one measurable physical parameter is location.

18. The data device according to embodiments 1-17, wherein: the at least one access sensor is configured for automatically switching to the enabled state upon determining that the location of the data device falls within a pre-defined range of geographic coordinates;

and the at least one access sensor is configured for automatically switching to the disabled state upon determining that the location of the data device falls outside of a pre-defined range of geographic coordinates.

19. The data device according to embodiments 1-18, wherein: the at least one access sensor is configured for automatically switching to the enabled state upon determining that the location of the data device falls within a pre-defined proximity to a given object; and the at least one access sensor is configured for automatically switching to the disabled state upon determining that the location of the data device falls outside of a pre-defined proximity to a given object.

20. The data device according to embodiments 1-19, wherein the at least one access sensor is an orientation sensor configured for measuring a current orientation of the data device relative to either an environment in which the data device is positioned or to another object, such that the at least one measurable physical parameter is orientation.

21. The data device according to embodiments 1-20, wherein: the at least one access sensor is configured for automatically switching to the enabled state upon determining that the orientation of the data device falls within a pre-defined range of orientation parameters; and the at least one access sensor is configured for automatically switching to the disabled state upon determining that the orientation of the data device falls outside of a pre-defined range of orientation parameters.

22. The data device according to embodiments 1-21, wherein the at least one access sensor is an acoustic sensor configured for detecting vibration in an environment in which the data device is positioned, such that the at least one measurable physical parameter is vibration.

23. The data device according to embodiments 1-22, wherein: the at least one access sensor is configured for automatically switching to the enabled state upon detecting the presence of vibration; and the at least one access sensor is configured for automatically switching to the disabled state upon detecting an absence of vibration.

24. The data device according to embodiments 1-23, wherein: the at least one access sensor is configured for automatically switching to the enabled state upon determining that a pre-defined minimum amount of vibration is present; and the at least one access sensor is configured for automatically switching to the disabled state upon determining that the pre-defined minimum amount of vibration is not present.

25. The data device according to embodiments 1-24, wherein: the at least one access sensor is configured for automatically switching to the enabled state upon determining that an amount of vibration detected falls within a pre-defined range; and the at least one access sensor is configured for automatically switching to the disabled state upon determining that an amount of vibration detected falls outside of a pre-defined range.

26. The data device according to embodiments 1-25, wherein: the at least one access sensor is configured for automatically switching to the enabled state upon detecting a pre-defined vibration or pattern of vibrations; and the at least one access sensor is configured for automatically switching to the disabled state upon not detecting the pre-defined vibration or pattern of vibrations.

27. The data device according to embodiments 1-26, wherein the at least one access sensor is a gas sensor configured for detecting an at least one gas in an environment in which the data device is positioned, such that the at least one measurable physical parameter is the at least one gas.

28. The data device according to embodiments 1-27, wherein: the at least one access sensor is configured for automatically switching to the enabled state upon detecting the presence of the at least one gas; and the at least one access sensor is configured for automatically switching to the disabled state upon detecting an absence of the at least one gas.

29. The data device according to embodiments 1-28, wherein: the at least one access sensor is configured for automatically switching to the enabled state upon determining that a pre-defined minimum amount of the at least one gas is present; and the at least one access sensor is configured for automatically switching to the disabled state upon determining that the pre-defined minimum amount of the at least one gas is not present.

30. The data device according to embodiments 1-29, wherein: the at least one access sensor is configured for automatically switching to the enabled state upon determining that an amount of the at least one gas detected falls within a pre-defined range; and the at least one access sensor is configured for automatically switching to the disabled state upon determining that an amount of the at least one gas detected falls outside of a pre-defined range.

31. The data device according to embodiments 1-30, wherein the at least one access sensor is a chemical sensor configured for detecting an at least one chemical in an environment in which the data device is positioned, such that the at least one measurable physical parameter is the at least one chemical.

32. The data device according to embodiments 1-31, wherein: the at least one access sensor is configured for automatically switching to the enabled state upon detecting the presence of the at least one chemical; and the at least one access sensor is configured for automatically switching to the disabled state upon detecting an absence of the at least one chemical.

33. The data device according to embodiments 1-32, wherein: the at least one access sensor is configured for automatically switching to the enabled state upon determining that a pre-defined minimum amount of the at least one chemical is present; and the at least one access sensor is configured for automatically switching to the disabled state upon determining that the pre-defined minimum amount of the at least one chemical is not present.

34. The data device according to embodiments 1-33, wherein: the at least one access sensor is configured for automatically switching to the enabled state upon determining that an amount of the at least one chemical detected falls within a pre-defined range; and the at least one access sensor is configured for automatically switching to the disabled state upon determining that an amount of the at least one chemical detected falls outside of a pre-defined range.

35. The data device according to embodiments 1-34, wherein the at least one access sensor is a radiation sensor configured for detecting radiation in an environment in which the data device is positioned, such that the at least one measurable physical parameter is radiation.

36. The data device according to embodiments 1-35, wherein: the at least one access sensor is configured for automatically switching to the enabled state upon detecting the presence of radiation; and the at least one access sensor is configured for automatically switching to the disabled state upon detecting an absence of radiation.

37. The data device according to embodiments 1-36, wherein: the at least one access sensor is configured for automatically switching to the enabled state upon determining that a pre-defined minimum amount of radiation is present; and the at least one access sensor is configured for automatically switching to the disabled state upon determining that the pre-defined minimum amount of radiation is not present.

38. The data device according to embodiments 1-37, wherein: the at least one access sensor is configured for automatically switching to the enabled state upon determining that an amount of radiation detected falls within a pre-defined range; and the at least one access sensor is configured for automatically switching to the disabled state upon determining that an amount of radiation detected falls outside of a pre-defined range.

39. The data device according to embodiments 1-38, wherein the at least one access sensor is a time sensor configured for measuring at least one of a current time or time interval, such that the at least one measurable physical parameter is time.

40. The data device according to embodiments 1-39, wherein: the at least one access sensor is configured for automatically switching to the enabled state upon reaching a pre-defined date and/or time; and the at least one access sensor is configured for automatically switching to the disabled state upon determining that the pre-defined date and/or time has not yet been reached.

41. The data device according to embodiments 1-40, wherein: the at least one access sensor is configured for automatically switching to the enabled state upon determining that a pre-defined amount of time has elapsed; and the at least one access sensor is configured for automatically switching to the disabled state upon determining that a pre-defined amount of time has not yet elapsed.

42. The data device according to embodiments 1-41, wherein the at least one access sensor is a pressure sensor configured for measuring an amount of pressure in the environment in which the data device is positioned, such that the at least one measurable physical parameter is pressure.

43. The data device according to embodiments 1-42, wherein: the at least one access sensor is configured for automatically switching to the enabled state upon determining that a pre-defined minimum amount of pressure is present; and the at least one access sensor is configured for automatically switching to the disabled state upon determining that a pre-defined minimum amount of pressure is not present.

44. The data device according to embodiments 1-43, wherein: the at least one access sensor is configured for automatically switching to the enabled state upon determining that an amount of pressure detected falls within a pre-defined range; and the at least one access sensor is configured for automatically switching to the disabled state upon determining that an amount of pressure detected falls outside of a pre-defined range.

45. A secure wireless data device configured as at least one of a passive, semi-passive, or active RFID or NFC enabled device, the data device comprising: a memory configured for storing select wireless data therein; an antenna in selective wireless communication with a compatible reader; and an at least one access sensor in electrical communication with each of the memory and antenna, the at least one access sensor configured for automatically switching between an enabled state—wherein communication between the memory and the antenna is enabled by the at least one access sensor, such that the wireless data is capable of being accessed by the reader—and a disabled state—wherein communication between the memory and the antenna is disabled by the at least one access sensor, such that the wireless data is prevented from being accessed by the reader—based on an at least one measurable physical parameter that is detectable by the at least one access sensor.

46. A secure wireless data device configured as at least one of a passive, semi-passive, or active RFID or NFC enabled payment card, the data device comprising: a memory configured for storing select wireless data therein; an antenna in selective wireless communication with a compatible reader; an at least one access sensor configured for automatically switching between an enabled state—wherein the wireless data is capable of being accessed by the reader—and a disabled state—wherein the wireless data is prevented from being accessed by the reader—based on an at least one measurable physical parameter that is detectable by the at least one access sensor; and at least one of the at least one access sensor is a light sensor configured for detecting light in an environment in which the data device is positioned, such that at least one of the at least one measurable physical parameter is light.

47. The data device according to embodiment 46, wherein the at least one access sensor is in electrical communication with each of the memory and antenna, such that the at least one access sensor is capable of selectively disabling communication between the memory and the antenna when the at least one access sensor is in the disabled state.

48. The data device according to embodiments 46-47, wherein the at least one access sensor is configured as a physical switch, wherein electrical communication between the memory and the antenna is selectively connected and disconnected by the at least one access sensor when the at least one access sensor is in the enabled and disabled states, respectively.

49. The data device according to embodiments 46-48, further comprising an at least one power source.

50. The data device according to embodiments 46-49, wherein the at least access sensor is in electrical communication with each of the power source and memory, such that the at least one access sensor is capable of selectively disconnecting the memory from the power source when the at least one access sensor is in the disabled state.

51. The data device according to embodiments 46-50, wherein: the at least one access sensor is configured for automatically switching to the enabled state upon detecting the presence of light; and the at least one access sensor is configured for automatically switching to the disabled state upon detecting an absence of light.

52. The data device according to embodiments 46-51, wherein: the at least one access sensor is configured for automatically switching to the enabled state upon determining that a pre-defined minimum amount of light is present; and the at least one access sensor is configured for automatically switching to the disabled state upon determining that the pre-defined minimum amount of light is not present.

In closing, regarding the exemplary embodiments of the present invention as shown and described herein, it will be appreciated that secure wireless data devices and associated methods of use are disclosed and configured for selectively controlling activation, deactivation, data access, data transmission and read/write/rewrite functionality of RFID and NFC enabled devices. Because the principles of the invention may be practiced in a number of configurations beyond those shown and described, it is to be understood that the invention is not in any way limited by the exemplary embodiments, but is generally directed to secure wireless data devices and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

Any claims intended to be treated under 35 U.S.C. § 112(f) will begin with the words “means for,” but use of the term “for” in any other context is not intended to invoke treatment under 35 U.S.C. § 112(f). Accordingly, Applicant reserves the right to pursue additional claims after filing this application, in either this application or in a continuing application.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment. Additionally, the various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

The methods as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A secure wireless data device configured as at least one of a passive, semi-passive, or active RFID or NFC enabled device, the data device comprising:
a memory configured for storing select wireless data therein;
an antenna in selective wireless communication with a compatible reader; and
an at least one access sensor configured for automatically switching between an enabled state—wherein the wireless data is capable of being accessed by the reader—and a disabled state—wherein the wireless data is prevented from being accessed by the reader—based on an at least one measurable physical parameter that is detectable by the at least one access sensor.

2. The data device of claim 1, wherein the at least one access sensor is in electrical communication with each of the memory and antenna, such that the at least one access sensor is capable of selectively disabling communication between the memory and the antenna when the at least one access sensor is in the disabled state.

3. The data device of claim 2, wherein the at least one access sensor is configured as a physical switch, wherein electrical communication between the memory and the antenna is selectively connected and disconnected by the at least one access sensor when the at least one access sensor is in the enabled and disabled states, respectively.

4. The data device of claim 1, further comprising an at least one power source.

5. The data device of claim 3, wherein the at least access sensor is in electrical communication with each of the power source and memory, such that the at least one access sensor is capable of selectively disconnecting the memory from the power source when the at least one access sensor is in the disabled state.

6. The data device of claim 1, wherein the at least one access sensor is a light sensor configured for detecting light in an environment in which the data device is positioned, such that the at least one measurable physical parameter is light.

7. The data device of claim 5, wherein:
the at least one access sensor is configured for automatically switching to the enabled state upon detecting the presence of light; and
the at least one access sensor is configured for automatically switching to the disabled state upon detecting an absence of light.

8. The data device of claim 5, wherein:
the at least one access sensor is configured for automatically switching to the enabled state upon determining that a pre-defined minimum amount of light is present; and
the at least one access sensor is configured for automatically switching to the disabled state upon determining that the pre-defined minimum amount of light is not present.

9. The data device of claim 1, wherein the at least one access sensor is a temperature sensor configured for measuring a temperature of an environment in which the data device is positioned, such that the at least one measurable physical parameter is temperature.

10. The data device of claim 1, wherein the at least one access sensor is a moisture sensor configured for detecting moisture in an environment in which the data device is positioned, such that the at least one measurable physical parameter is moisture.

11. The data device of claim 1, wherein the at least one access sensor is a location sensor configured for measuring a current location of the data device relative to either an environment in which the data device is positioned or to another object, such that the at least one measurable physical parameter is location.

12. The data device of claim 1, wherein the at least one access sensor is an orientation sensor configured for measuring a current orientation of the data device relative to either an environment in which the data device is positioned or to another object, such that the at least one measurable physical parameter is orientation.

13. The data device of claim 1, wherein the at least one access sensor is an acoustic sensor configured for detecting vibration in an environment in which the data device is positioned, such that the at least one measurable physical parameter is vibration.

14. The data device of claim 1, wherein the at least one access sensor is a gas sensor configured for detecting an at least one gas in an environment in which the data device is positioned, such that the at least one measurable physical parameter is the at least one gas.

15. The data device of claim 1, wherein the at least one access sensor is a chemical sensor configured for detecting an at least one chemical in an environment in which the data device is positioned, such that the at least one measurable physical parameter is the at least one chemical.

16. The data device of claim 1, wherein the at least one access sensor is a radiation sensor configured for detecting radiation in an environment in which the data device is positioned, such that the at least one measurable physical parameter is radiation.

17. The data device of claim 1, wherein the at least one access sensor is a time sensor configured for measuring at least one of a current time or time interval, such that the at least one measurable physical parameter is time.

18. The data device of claim 1, wherein the at least one access sensor is a pressure sensor configured for measuring an amount of pressure in the environment in which the data device is positioned, such that the at least one measurable physical parameter is pressure.

19. A secure wireless data device configured as at least one of a passive, semi-passive, or active RFID or NFC enabled device, the data device comprising:
a memory configured for storing select wireless data therein;
an antenna in selective wireless communication with a compatible reader; and
an at least one access sensor in electrical communication with each of the memory and antenna, the at least one access sensor configured for automatically switching between an enabled state—wherein communication between the memory and the antenna is enabled by the at least one access sensor, such that the wireless data is capable of being accessed by the reader—and a disabled state—wherein communication between the memory and the antenna is disabled by the at least one access sensor, such that the wireless data is prevented from being accessed by the reader—based on an at least one measurable physical parameter that is detectable by the at least one access sensor.

20. A secure wireless data device configured as at least one of a passive, semi-passive, or active RFID or NFC enabled payment card, the data device comprising:
a memory configured for storing select wireless data therein;
an antenna in selective wireless communication with a compatible reader;
an at least one access sensor configured for automatically switching between an enabled state—wherein the wireless data is capable of being accessed by the reader—and a disabled state—wherein the wireless data is prevented from being accessed by the reader—based on an at least one measurable physical parameter that is detectable by the at least one access sensor; and
at least one of the at least one access sensor is a light sensor configured for detecting light in an environment in which the data device is positioned, such that at least one of the at least one measurable physical parameter is light.
